(19) United States
(12) Patent Application Publication
(10) Pub. No.: US 2003/0034204 A1
(43) Pub. Date: Feb. 20, 2003

(54) Fire escape chute for a building

(76) Inventors: Daniel E. Dotson, Glen, WV (US); Pete R. Bishop, Glen, WV (US)

Correspondence Address: Richard W. Goldstein, 2071 Clove Road, Staten Island, NY, 10304, US

(21) Appl. No.: 09/735,050

(22) Filed: Dec. 13, 2000

(51) Int. Cl. A62B 1/20

(52) U.S. Cl. 182/48; 472/116

(57) ABSTRACT

A fire escape chute for a building including an elongated tube having an open upper end, an open lower end, and an intermediate extent therebetween. The elongated tube includes a support structure secured to and supporting the intermediate extent thereof whereby the open upper end is positioned within the opening of the building and the open lower end is positioned on the ground surface. A door is hingedly coupled with the open upper end of the elongated tube.

### BACKGROUND OF THE INVENTION

The present invention relates to a fire escape chute for a building and more particularly pertains to allowing people trapped above a first floor of a building during a fire to safely escape the building.

Typically, most buildings and houses have more than one floor. The problem with this type of construction is that in case of fire, escape from these upper floors is frequently difficult and usually dangerous. Some larger buildings are provided with fire escapes that will allow people stranded on upper floors to flee a fire or other dangerous situations. Problems exist with smaller buildings which do not provide any means for a person on an upper floor to escape in the event of a fire. What is needed is a structure that will allow a person trapped on an upper floor in a building or hose to escape therefrom in the event of a fire or other dangerous situation.

The present invention attempts to solve the abovementioned problem by providing a slide that can be attached to a house or building that will allow a person on an upper floor to escape to the ground safely.

The use of fire escape devices is known in the prior art. More specifically, fire escape devices heretofore devised and utilized for the purpose of providing an escape from a fire are known to consist basically of familiar, expected and obvious structural configurations, notwithstanding the myriad of designs encompassed by the crowded prior art which have been developed for the fulfillment of countless objectives and requirements.

By way of example, U.S. Pat. No. 4,705,141 to Splaine discloses a flexible mesh tube attached to a frame for escape through a window in the event of a fire. U.S. Pat. No. 1,497,609 to Sturges discloses a tubular fire escape with a closure for the outlet end. U.S. Pat. Nos. 4,398,621 to Baker and 5,060,753 to Hopkins disclose additional fire escape chutes for buildings.

While these devices fulfill their respective, particular objective and requirements, the aforementioned patents do not describe a fire escape chute for a building for allowing people trapped above a first floor of a building during a fire to safely escape the building.

In this respect, the fire escape chute for a building according to the present invention substantially departs from the conventional concepts and designs of the prior art, and in doing so provides an apparatus primarily developed for the purpose of allowing people trapped above a first floor of a building during a fire to safely escape the building.

Therefore, it can be appreciated that there exists a continuing need for a new and improved fire escape chute for a building which can be used for allowing people trapped above a first floor of a building during a fire to safely escape the building. In this regard, the present invention substantially fulfills this need.

### SUMMARY OF THE INVENTION

In the view of the foregoing disadvantages inherent in the known types of fire escape devices now present in the prior art, the present invention provides an improved fire escape chute for a building. As such, the general purpose of the present invention, which will be described subsequently in greater detail, is to provide a new and improved fire escape chute for a building which has all the advantages of the prior art and none of the disadvantages.

To attain this, the present invention essentially comprises an elongated tube having an open upper end, an open lower end, and an intermediate extent therebetween. The elongated tube includes a support structure secured to and supporting the intermediate extent thereof whereby the open upper end is positioned within the opening of the building and the open lower end is positioned on the ground surface. The open lower end has a screen removably disposed therein. A door is hingedly coupled with the open upper end of the elongated tube. The door has an inner surface and an outer surface. The inner surface has a lock disposed therein. The inner surface has a handle disposed thereon. The door includes a slide catch to prevent the door from accidentally closing while in an open orientation.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved fire escape chute for a building which has all the advantages of the prior art fire escape devices and none of the disadvantages.

It is another object of the present invention to provide a new and improved fire escape chute for a building which may be easily and efficiently manufactured and marketed.

It is a further object of the present invention to provide a new and improved fire escape chute for a building which is of durable and reliable construction.

An even further object of the present invention is to provide a new and improved fire escape chute for a building which is susceptible of a low cost of manufacture with regard to both materials and labor, and which accordingly is then susceptible of low prices of sale to the consuming public, thereby making such a fire escape chute for a building economically available to the buying public.

Even still another object of the present invention is to provide a new and improved fire escape chute for a building for allowing people trapped above a first floor of a building during a fire to safely escape the building.

Lastly, it is an object of the present invention to provide a new and improved fire escape chute for a building including an elongated tube having an open upper end, an open lower end, and an intermediate extent therebetween. The elongated tube includes a support structure secured to and supporting the intermediate extent thereof whereby the open upper end is positioned within the opening of the building and the open lower end is positioned on the ground surface. A door is hingedly coupled with the open upper end of the elongated tube.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the fire escape chute for a building constructed in accordance with the principles of the present invention.

FIG. 2 is a rear view of the escape door of the present invention.

FIG. 3 is a front view of the escape door of the present invention.

The same reference numerals refer to the same parts through the various figures.

### DESCRIPTION OF THE PREFERRED EMBODIMENT

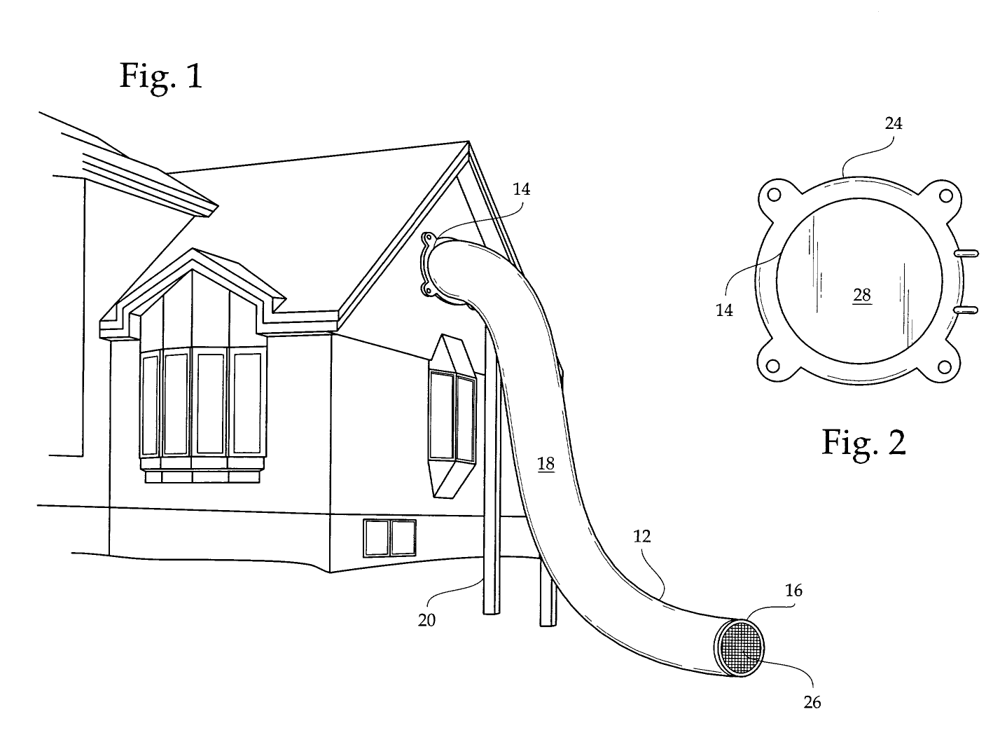

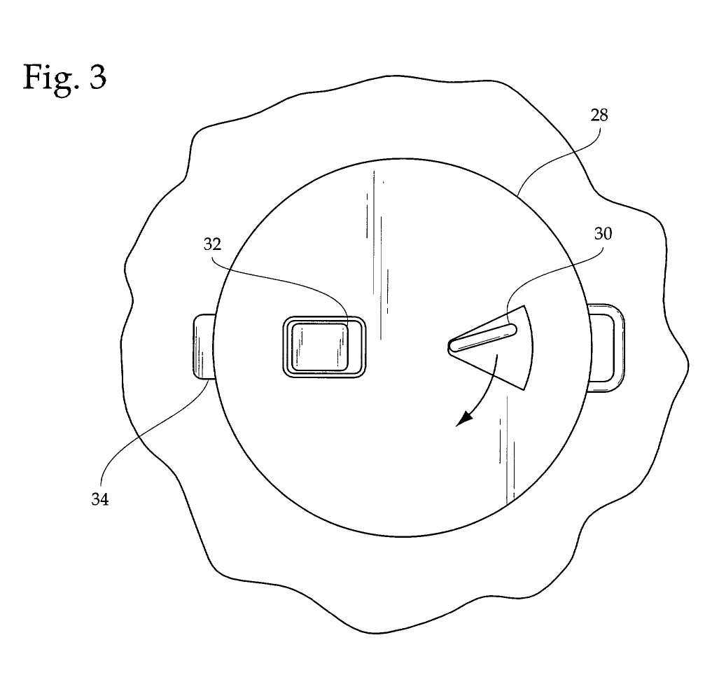

With reference now to the drawings, and in particular, to FIGS. 1 through 3 thereof, the preferred embodiment of the new and improved fire escape chute for a building embodying the principles and concepts of the present invention and generally designated by the reference number 10 will be described.

Specifically, it will be noted in the various figures that the device relates to a fire escape chute for a building for allowing people trapped above a first floor of a building during a fire to safely escape the building. In its broadest context, the device consists of an elongated tube and a door. Such components are individually configured and correlated with respect to each other so as to attain the desired objective.

The present invention is designed for use on a house or building that has more than one floor. The typical application will be on two story residences. The present invention is designed for use with a window on an upper floor as an after-market product or can be used with an opening formed within the house during construction of the house.

The elongated tube 12 has an open upper end 14, an open lower end 16, and an intermediate extent 18 therebetween. The elongated tube 12 is preferably constructed of a rigid plastic. The tube 12 can also be constructed in sections that can be molded or secured together to complete the tube. The elongated tube 12 includes a support structure 20 secured to and supporting the intermediate extent 18 thereof whereby the open upper end 14 is positioned within the opening of the building and the open lower end 16 is positioned on the ground surface. The open upper end 14 is disposed within the opening whereby a peripheral bracket 24 is used to secure the tube 12 to the building. Note FIGS. 1 and 2. The open lower end 16 has a screen 26 removably disposed therein. The screen 26 can be provided with means for it's removal from an interior of the tube 12. The screen 26, while in place, will prevent animals or the like from gaining access to the tube 12.

The door 28 is hingedly coupled with the open upper end 14 of the elongated tube 12. The door 28 has an inner surface and an outer surface. The inner surface has a lock 30 disposed therein. When the lock 30 has been disengaged, an alarm can be sounded. The present invention can be wired into an existing alarm system of the building. The inner surface has a handle 32 disposed thereon. The door 28 includes a slide catch 34 to prevent the door 28 from accidentally closing while in an open orientation. In use, a person would simply disengage the lock 30 and open the door 28 and enter the tube 12 through the open upper end 14 thereof and proceed down the tube 12 to the open lower end 16. The screen 26 would be removed to allow the person to exit the tube 12.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by LETTERS PATENT of the United States is as follows:

1. A fire escape chute for a building for allowing people trapped above a first floor of a building during a fire to safely escape the building, wherein an opening is formed above the first floor and the building is positioned on a ground surface, the fire escape chute comprising, in combination:
an elongated tube having an open upper end, an open lower end, and an intermediate extent therebetween, the elongated tube including a support structure secured to and supporting the intermediate extent thereof whereby the open upper end is positioned within the opening of the building and the open lower end is positioned on the ground surface, the open lower end having a screen removably disposed therein; and
a door hingedly coupled with the open upper end of the elongated tube, the door having an inner surface and an outer surface, the inner surface having a lock disposed therein, the inner surface having a handle disposed thereon, the door including a slide catch to prevent the door from accidentally closing while in an open orientation.

2. A fire escape chute for a building for allowing people trapped above a first floor of a building during a fire to safely escape the building, wherein an opening is formed above the first floor and the building is positioned on a ground surface, the fire escape chute comprising, in combination:
an elongated tube having an open upper end, an open lower end, and an intermediate extent therebetween, the elongated tube including a support structure secured to and supporting the intermediate extent thereof whereby the open upper end is positioned within the opening of the building and the open lower end is positioned on the ground surface; and
a door hingedly coupled with the open upper end of the elongated tube.

3. The fire escape chute for a building as set forth in claim 2, wherein the open lower end of the elongated tube has a screen removably disposed therein.

4. The fire escape chute for a building as set forth in claim 2, wherein the door has a lock disposed therein.

5. The fire escape chute for a building as set forth in claim 2, wherein the door has a handle disposed thereon.

6. The fire escape chute for a building as set forth in claim 2, wherein the door includes a slide catch to prevent the door from accidentally closing while in an open orientation.
